(19) United States
(12) Patent Application Publication
(10) Pub. No.: US 2024/0072277 A1
(43) Pub. Date: Feb. 29, 2024

(54) FUEL CELL SYSTEM

(71) Applicant: HONDA MOTOR CO., LTD., TOKYO (JP)

(72) Inventor: Shuji SATO, WAKO-SHI (JP)

(21) Appl. No.: 18/232,502

(22) Filed: Aug. 10, 2023

(30) Foreign Application Priority Data
Aug. 31, 2022 (JP) 2022-137381

(51) Int. Cl. H01M 8/04119; B60L 50/70; H01M 8/04223; H01M 8/043; H01M 8/0432; H01M 8/04746; H01M 8/04828; H01M 8/04858

(52) U.S. Cl. CPC H01M 8/04179; B60L 50/70; H01M 8/04253; H01M 8/043; H01M 8/0432; H01M 8/04753; H01M 8/04828; H01M 8/0494; H01M 2250/20

(57) ABSTRACT

A fuel cell system includes a controller for controlling an oxygen-containing gas supply device and a fuel gas supply device. The controller causes a fuel cell stack to perform specific power generation for a first predetermined time for increasing water in the fuel cell stack after stopping normal operation of the fuel cell system, and thereafter supplies an oxygen-containing gas to the fuel cell stack for a second predetermined time to reduce water inside the fuel cell stack.

### CROSS-REFERENCE TO RELATED APPLICATIONS

This application is based upon and claims the benefit of priority from Japanese Patent Application No. 2022-137381 filed on Aug. 31, 2022, the contents of which are incorporated herein by reference.

### BACKGROUND OF THE INVENTION

### Field of the Invention

The present invention relates to a fuel cell system to be mounted on a moving object or the like.

### Description of the Related Art

In recent years, research and development have been conducted on fuel cell systems that contribute to energy efficiency in order to ensure that more people have access to affordable, reliable, sustainable and modern energy. For example, there is a fuel cell vehicle equipped with a fuel cell system. The fuel cell vehicle travels by driving an electric motor using electrical power that is generated by the fuel cell system. Fuel cell vehicles are more environmentally friendly than gasoline-powered vehicles or the like that emit CO₂, NOₓ, SOₓ because the fuel cell vehicles merely discharge water. The fuel cell system may be mounted on other moving objects such as ships, aircrafts, robots, and so on, in addition to automobiles.

The fuel cell system includes a fuel cell stack that generates electricity through electrochemical reactions between an oxygen-containing gas and a fuel gas. Water generated during power generation may remain inside the fuel cell stack. In this case, the water may freeze depending on the environment around the fuel cell stack. When the water remaining inside the fuel cell stack freezes, the power generation efficiency of the fuel cell stack tends to decrease.

JP 2007-053015 A discloses that when the operation of a fuel cell system is stopped, a gas is supplied to the inside of a fuel cell stack so that the water remaining in the fuel cell stack is purged.

### SUMMARY OF THE INVENTION

However, the amount of water remaining inside the fuel cell stack is unknown. Therefore, there may be a problem that the inside of the fuel cell stack is excessively dried by the gas excessively supplied to the inside of the fuel cell stack. Although it has been proposed to use a sensor to estimate the amount of water remaining in the fuel cell stack, a problem similar to that described above may occur in the case of sensor trouble.

An object of the present invention is to solve the aforementioned problem.

According to an aspect of the present invention, there is provided a fuel cell system including a fuel cell stack configured to generate electricity by electrochemical reactions between an oxygen-containing gas and a fuel gas, the fuel cell system including: the oxygen-containing gas supply device configured to provide the oxygen-containing gas to be supplied to the fuel cell stack; a fuel gas supply device configured to provide the fuel gas to be supplied to the fuel cell stack; and a controller configured to control the oxygen-containing gas supply device and the fuel gas supply device, wherein the controller is configured to cause the fuel cell stack to perform a specific power generation for a first predetermined period of time after stopping normal operation of the fuel cell system, wherein an increased amount of water is produced inside the fuel cell stack during the specific power generation, and wherein the controller is configured to cause the oxygen-containing gas to be supplied to the fuel cell stack for a second predetermined period of time during which water inside the fuel cell stack is reduced.

According to the aspect of the present invention, it is possible to purge water inside the fuel cell stack after a state (saturated state) in which the amount of water has become substantially the theoretical value is established. Therefore, it is possible to prevent the inside of the fuel cell stack from being excessively dried off even without using a sensor. As a result, it is possible to suppress a decrease in power generation efficiency due to freezing of water remaining inside the fuel cell stack. The present invention thus contributes to energy efficiency.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a configuration of a fuel cell system according to an embodiment;

FIG. 2 is a flowchart showing a procedure of freezing-suppression processing; and

FIG. 3 is a flowchart showing a procedure of freezing-suppression processing according to a modified embodiment.

### DETAILED DESCRIPTION OF THE INVENTION

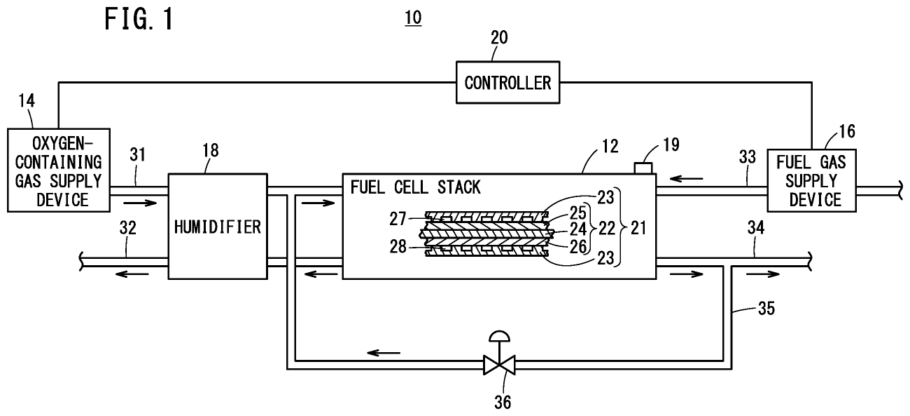

FIG. 1 is a schematic diagram showing a configuration of a fuel cell system 10 according to an embodiment. The fuel cell system 10 may be mounted on a moving object such as a vehicle, a ship, an aircraft, a robot and so on. In the present embodiment, the fuel cell system 10 is mounted on a vehicle. The fuel cell system 10 includes a fuel cell stack 12, an oxygen-containing gas supply device 14, a fuel gas supply device 16, a humidifier 18, a temperature sensor 19, and a controller 20.

The fuel cell stack 12 generates electric power through electrochemical reactions between a fuel gas and an oxygen-containing gas. The oxygen-containing gas is a gas containing oxygen. The fuel gas is a gas containing hydrogen. The oxygen-containing gas may be air. The electric energy obtained by electricity generated by the fuel cell stack 12 is stored in a storage battery. The electric energy stored in the storage battery is used as the drive force for driving the vehicle or the fuel cell system 10.

The fuel cell stack 12 includes a plurality of power generation cells 21. The plurality of power generation cells 21 are stacked. Each power generation cell 21 includes a membrane electrode assembly 22 and a pair of separators 23 sandwiching the membrane electrode assembly 22. The membrane electrode assembly 22 is, for example, equipped with an electrolyte membrane 24 in which a thin film of perfluorosulfonic acid is impregnated with water, and a cathode 25 and an anode 26 sandwiching the electrolyte membrane 24.

The fuel cell stack 12 also includes a cathode flow field 27 and an anode flow field 28. The cathode flow field 27 is formed between the separator 23 and the cathode 25. The cathode flow field 27 communicates with an oxygen-containing gas supply passage 31 and an oxygen-containing gas discharge passage 32 that are disposed outside the fuel cell stack 12. The anode flow field 28 is formed between the separator 23 and the anode 26. The anode flow field 28 communicates with a fuel gas supply passage 33 and a fuel gas discharge passage 34 that are disposed outside the fuel cell stack 12.

The oxygen-containing gas supply device 14 is a device that provides the oxygen-containing gas to be supplied to the fuel cell stack 12. The oxygen-containing gas supply device 14 adjusts the supply amount of the oxygen-containing gas (oxygen-containing gas flow rate) under the control of the controller 20. Examples of the oxygen-containing gas supply device 14 include a compressor and the like. The oxygen-containing gas provided by the oxygen-containing gas supply device 14 is supplied to the cathode flow field 27 of the fuel cell stack 12 via the oxygen-containing gas supply passage 31. A part of the oxygen-containing gas having flowed through the cathode flow field 27 flows out from the fuel cell stack 12 to the oxygen-containing gas discharge passage 32 as off-gas.

The fuel gas supply device 16 is a device that provides the fuel gas to be supplied to the fuel cell stack 12. The fuel gas supply device 16 adjusts the supply amount of the fuel gas (fuel gas flow rate) under the control of the controller 20. Examples of the fuel gas supply device 16 include an injector and the like. The fuel gas provided by the fuel gas supply device 16 is supplied to the anode flow field 28 of the fuel cell stack 12 via the fuel gas supply passage 33. A part of the fuel gas having flowed through the anode flow field 28 flows out from the fuel cell stack 12 to the fuel gas discharge passage 34 as off-gas.

The humidifier 18 introduces water vapor into the oxygen-containing gas supply passage 31 to humidify the oxygen-containing gas flowing through the oxygen-containing gas supply passage 31. The humidifier 18 collects water contained in the off-gas flowing through the oxygen-containing gas discharge passage 32 and vaporizes the water into water vapor. The humidifier 18 may introduce the vaporized water (water vapor) into the oxygen-containing gas supply passage 31.

The fuel cell stack 12 is provided with a temperature sensor 19 for detecting a temperature of the fuel cell stack 12. The temperature detected by the temperature sensor 19 may be an average of temperatures detected at a plurality of locations of the fuel cell stack 12 or may be a representative temperature. The representative temperature is, for example, a temperature at an outlet portion of the fuel cell stack 12 from which the fuel gas is discharged as the off-gas.

The controller 20 includes one or more processors and a storage medium. The controller 20 executes various kinds of processing based on computations by the one or more processors. The controller 20 may be provided in an ECU of the vehicle. The storage medium includes a volatile memory such as a RAM (random access memory) and a nonvolatile memory such as a ROM (read-only memory), a flash memory, and a hard disk. At least a part of the storage medium may be provided in the one or more processors.

The controller 20 controls the fuel cell system 10 based on an ignition switch. The ignition switch is a switch for starting (turning on) or stopping (turning off) operation of the vehicle (moving body). When the ignition switch is turned on, an electric motor mounted on the moving body is driven. The electric motor is one of supply destinations to which electric power generated by the fuel cell stack 12 is supplied.

The controller 20 causes the fuel cell system 10 to execute normal operation during a vehicle operation period from when the ignition switch is turned on to when the ignition switch is turned off. During the normal operation of the fuel cell system 10, the controller 20 causes the fuel cell stack 12 to generate electricity. In this case, the controller 20 controls the oxygen-containing gas supply device 14 to supply the oxygen-containing gas to the fuel cell stack 12, and controls the fuel gas supply device 16 to supply the fuel gas to the fuel cell stack 12. Further, the controller 20 controls the oxygen-containing gas supply device 14 to adjust the flow rate of the oxygen-containing gas, and controls the fuel gas supply device 16 to adjust the flow rate of the fuel gas. In this case, the controller 20 adjusts the flow rates so that the ratio of the oxygen-containing gas to the fuel gas becomes the reference ratio determined by the target amount of electricity.

When the ignition switch is turned off, the controller 20 stops the operation of the fuel cell system 10. While the operation of the fuel cell system 10 is stopped, the controller stops the power generation operation of the fuel cell stack 12. In this case, the controller 20 stops driving the oxygen-containing gas supply device 14 and the fuel gas supply device 16. Therefore, the oxygen-containing gas and the fuel gas are not supplied to the fuel cell stack 12, and the fuel cell stack 12 does not generate electricity.

The controller 20 executes a freezing-suppression processing after the stop of the operation of the fuel cell system 10. The freezing-suppression processing is executed for suppressing freezing of water remaining inside the fuel cell stack 12.

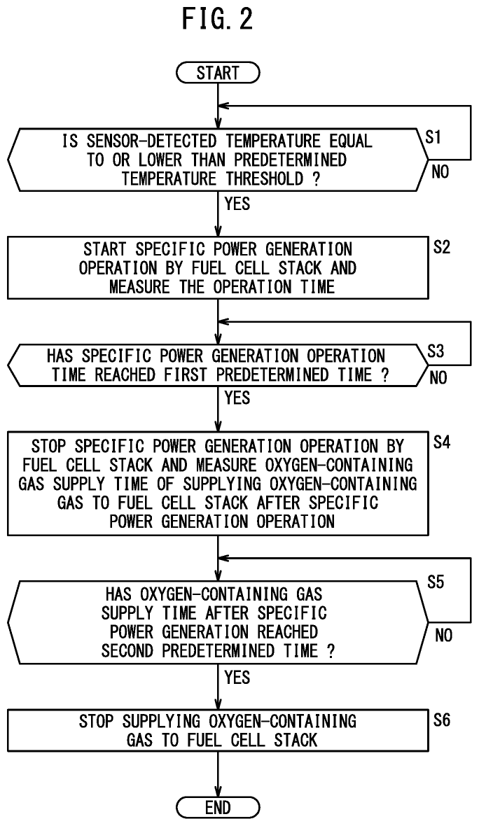

FIG. 2 is a flowchart showing a procedure of freezing-suppression processing according to the present embodiment. The freezing-suppression processing is executed during a period from when the operation of the vehicle (moving object) is stopped to when the vehicle is activated next time. The freezing-suppression processing starts after the ignition switch is turned off.

In step S1, the controller 20 compares the temperature detected by the temperature sensor 19 with a predetermined temperature threshold. In the case that the temperature exceeds the temperature threshold, the controller 20 determines that there is a low possibility that water remaining inside the fuel cell stack 12 will freeze. In this case, the freezing-suppression processing remains at step S1. On the other hand, in the case that the temperature is equal to or lower than the temperature threshold, the controller 20 determines that there is a high possibility that water remaining inside the fuel cell stack 12 will freeze. In this case, the freezing-suppression processing transitions to step S2.

In step S2, the controller 20 causes the fuel cell stack 12 to start specific power generation. In the specific power generation, the amount of water to be produced inside the fuel cell stack 12 increases. In this case, even though the ignition switch is in the off state, the controller 20 activates the oxygen-containing gas supply device 14 and the fuel gas supply device 16 to supply the oxygen-containing gas and the fuel gas to the fuel cell stack 12.

In the present embodiment, the controller 20 causes the fuel cell stack 12 to execute low stoichiometric power generation as the specific power generation. In this case, the controller 20 decreases the amount of the oxygen-containing gas supplied to the fuel cell stack 12 so that the ratio of the oxygen-containing gas to the fuel gas becomes lower than the reference ratio determined by the target amount of electricity. For example, the controller 20 supplies the fuel cell stack 12 with the same amount of fuel gas as the amount of fuel gas supplied during the normal power generation. On the other hand, the controller 20 supplies the fuel cell stack 12 with an amount of oxygen-containing gas smaller than the amount of oxygen-containing gas supplied during the normal power generation. During the normal power generation, electric power is generated using the fuel gas and the oxygen-containing gas in the amounts determined based on the target amount of electricity.

When causing the fuel cell stack 12 to start the specific power generation, the controller 20 starts measuring the elapsed time of the specific power generation. When the measurement of the elapsed time of the specific power generation is started, the freezing-suppression processing transitions to step S3.

In step S3, the controller 20 determines whether or not the elapsed time of the specific power generation has reached the first predetermined time. Until the elapsed time of the specific power generation has reached the first predetermined time, the controller 20 determines that water produced by power generation is not enough to saturate the inside of the fuel cell stack 12 with water. In this case, the freezing-suppression processing remains at step S3. On the other hand, when the elapsed time of the specific power generation has reached the first predetermined time, the controller 20 determines that the water produced by power generation saturates the inside of the fuel cell stack 12 with water. In this case, the controller 20 ends the measurement of the elapsed time of the specific power generation. When the measurement ends, the freezing-suppression processing transitions to step S4.

In step S4, the controller 20 causes the fuel cell stack 12 to stop the specific power generation and reduces the amount of water that has produced inside the fuel cell stack 12 by power generation. In this case, the controller 20 may stop the fuel gas supply device 16 to stop the supply of the fuel gas to the fuel cell stack 12. On the other hand, the controller 20 continues to drive the oxygen-containing gas supply device 14 to continue the supply of the oxygen-containing gas to the fuel cell stack 12.

While the supply of the oxygen-containing gas to the fuel cell stack 12 is continued, the water produced by power generation and remaining in the fuel cell stack 12 is discharged to the outside of the fuel cell stack 12. A part of water inside the fuel cell stack 12 is evaporated by the heat generated at the fuel cell stack 12 during the specific power generation. In the present embodiment, executed as the specific power generation is the low stoichiometric power generation. In the low stoichiometric power generation, the amount of the oxygen-containing gas supplied to the fuel cell stack 12 is smaller than that in the normal power generation, and thus the power generation efficiency of the fuel cell stack 12 is lowered. Therefore, the temperature of the fuel cell stack 12 rises faster than in the normal power generation, and a larger amount of water is evaporated by the heat at the fuel cell stack 12 than in the normal power generation. As a result, the water remaining in the fuel cell stack 12 can be quickly discharged to the outside of the fuel cell stack 12.

After causing the fuel cell stack 12 to stop the specific power generation, the controller 20 may supply a larger amount of oxygen-containing gas than the amount of oxygen-containing gas supplied during the specific power generation. In this case, the controller 20 can quickly discharge the water remaining inside the fuel cell stack 12 to the outside of the fuel cell stack 12.

When causing the fuel cell stack 12 to stop the specific power generation, the controller 20 starts measuring the time of supplying the oxygen-containing gas to the fuel cell stack 12. With the start of the measurement of the time during which the oxygen-containing gas is supplied to the fuel cell stack 12 after the specific power generation is stopped, the freezing-suppression processing transitions to step S5.

In step S5, the controller 20 determines whether or not the time during which the oxygen-containing gas is supplied to the fuel cell stack 12 after the specific power generation is stopped has reached a second predetermined time. Until the time of supplying the oxygen-containing gas to the fuel cell stack 12 after the stop of the specific power generation has reached the second predetermined time, the controller 20 determines that water remains in the fuel cell stack 12. In this case, the freezing-suppression processing remains at step S5. On the other hand, when the time of supplying the oxygen-containing gas to the fuel cell stack 12 after the stop of the specific power generation has reached the second predetermined time, the controller 20 determines that no water remains in the fuel cell stack 12. In this case, the controller 20 ends the measurement of the time of supplying the oxygen-containing gas to the fuel cell stack 12 after the specific power generation is stopped. When the measurement ends, the freezing-suppression processing transitions to step S6.

In step S6, the controller 20 stops the oxygen-containing gas supply device 14 to stop supplying the oxygen-containing gas to the fuel cell stack 12. When the supply of the oxygen-containing gas to the fuel cell stack 12 is stopped, the freezing prevention process is terminated.

The above-described embodiment may be modified as described below.

### Modified Embodiment 1

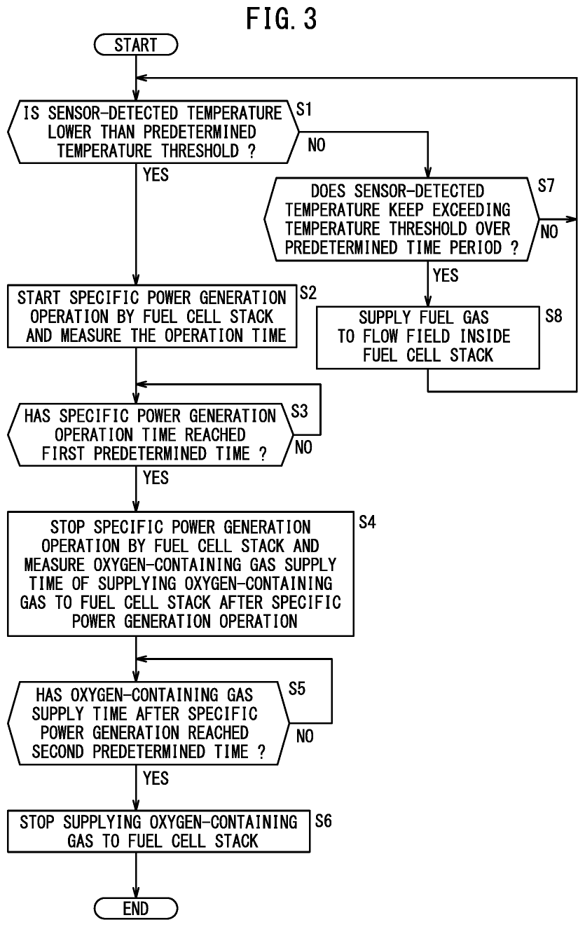

FIG. 3 is a flowchart showing a procedure of freezing-suppression processing according to a modified embodiment. The freezing-suppression processing according to the modified embodiment includes step S7 and step S8 in addition to step S1 to step S6 described above.

In the present modification, when the temperature detected by the temperature sensor 19 exceeds the temperature threshold, the freezing-suppression processing transitions to step S7. In step S7, the controller 20 determines whether or not a state in which the temperature detected by the temperature sensor 19 exceeds the temperature threshold has continued for a predetermined period of time.

In the case that a state in which the temperature detected by the temperature sensor 19 exceeds the temperature threshold has not lasted for the predetermined period of time, the controller 20 determines that the vehicle (moving object) has stopped for a relatively short period of time. In this case, the freezing-suppression processing returns to step S1.

On the other hand, in the case that the state in which the temperature detected by the temperature sensor 19 exceeds the temperature threshold has lasted for the predetermined period of time, the controller 20 determines that the vehicle (moving object) has stopped for a relatively long period of time. In this case, the freezing-suppression processing transitions to step S8.

In step S8, even if the ignition switch is off, the controller 20 drives the fuel gas supply device 16 to supply the fuel gas to the fuel cell stack 12. In this case, when the anode flow field 28 in the fuel cell stack 12 is filled with the fuel gas supplied to the fuel cell stack 12, the fuel gas permeates through the electrolyte membrane 24 and reaches the cathode flow field 27 with time. Then, an oxygen-free environment can be maintained in the fuel cell stack 12 so that deterioration of the fuel cell stack 12 can be suppressed.

### Modified Embodiment 2

In step S8, the controller 20 may drive the fuel gas supply device 16 and open an on-off valve 36 (FIG. 1) provided in a relay passage 35 (FIG. 1). The relay passage 35 is a flow path connecting the oxygen-containing gas supply passage 31 and the fuel gas discharge passage 34. An inlet of the relay passage 35 is connected to the fuel gas discharge passage 34. The outlet of the relay passage 35 is connected to the oxygen-containing gas supply passage 31 between the humidifier 18 and the fuel cell stack 12.

When the on-off valve 36 provided in the relay passage 35 is opened, the fuel gas flowing out from the fuel cell stack 12 to the fuel gas discharge passage 34 flows into the oxygen-containing gas supply passage 31 via the relay passage 35. The fuel gas flowing into the oxygen-containing gas supply passage 31 flows out from the fuel cell stack 12 to the oxygen-containing gas discharge passage 32 via the cathode flow field 27 inside the fuel cell stack 12.

Therefore, the fuel gas can be rapidly supplied to the flow fields (the anode flow field 28 and the cathode flow field 27) in the fuel cell stack 12 as compared with the Modified Embodiment 1.

### Modified Embodiment 3

The fuel cell system 10 may supply electric power generated in the specific power generation by the fuel cell stack 12 to at least one of the oxygen-containing gas supply device 14 and the fuel gas supply device 16 as the drive power. Thus, energy efficiency can be improved.

The invention grasped from the above-described embodiments and modified embodiments will be described below.

(1) The present invention provides the fuel cell system (10) including the fuel cell stack (12) configured to generate electricity by electrochemical reactions between the oxygen-containing gas and the fuel gas, the fuel cell system (10) including: the oxygen-containing gas supply device (14) configured to provide the oxygen-containing gas to be supplied to the fuel cell stack (12); the fuel gas supply device (16) configured to provide the fuel gas to be supplied to the fuel cell stack (12); and the controller (20) configured to control the oxygen-containing gas supply device (14) and the fuel gas supply device (16), wherein the controller (20) is configured to cause the fuel cell stack (12) to perform the specific power generation for the first predetermined period of time for increasing water inside the fuel cell stack (12) after stopping normal operation of the fuel cell system (10), and wherein after the specific power generation executed for the first predetermined period of time, the controller (20) is configured to cause the oxygen-containing gas to be supplied to the fuel cell stack (12) for the second predetermined period of time during which the water inside the fuel cell stack (12) is reduced.

This makes it possible to start purging the water remaining inside the fuel cell stack from a state (saturated state) in which the amount of water inside the fuel cell stack has become substantially the theoretical value. Therefore, it is possible to prevent the inside of the fuel cell stack from being excessively dried off even without using a sensor, while suppressing a decrease in power generation efficiency due to freezing of water remaining inside the fuel cell stack. The present invention thus contributes to energy efficiency.

(2) The fuel cell system (10) of the present invention may further include a temperature sensor (19) configured to detect a temperature of the fuel cell stack (12), wherein the controller (20) may cause the fuel cell stack (12) to start the specific power generation when the temperature becomes equal to or lower than a predetermined temperature threshold after stopping the normal operation of the fuel cell system (10). Thus, it is possible to prevent the specific power generation from being executed even in the case of no possibility of freezing of water.

(3) In the fuel cell system (10) of the invention, the controller (20) may supply the fuel gas to the fuel cell stack (12) when a state in which the temperature exceeds the temperature threshold has continued for a predetermined period of time after stopping the normal operation of the fuel cell system (10). Thus, water in the fuel cell stack can be purged. In addition, it is possible to suppress deterioration of the fuel cell stack while the fuel cell stack is not used for a long period of time.

(4) In the fuel cell system (10) of the present invention, the controller (20) may decrease the amount of the oxygen-containing gas to be supplied to the fuel cell stack (12) during the specific power generation such that the ratio of the oxygen-containing gas to the fuel gas becomes lower than the reference ratio determined by the target amount of electricity. As a result, the power generation efficiency of the fuel cell stack decreases during the specific power generation and the temperature of the fuel cell stack rises quickly. In this manner, it is possible to increase water produced inside the fuel cell stack while heating the fuel cell stack. In addition, the amount of water evaporated by the heat of the fuel cell stack increases with time. Therefore, when the oxygen-containing gas is supplied to the fuel cell stack after the specific power generation, the water in the fuel cell stack can be rapidly reduced.

(5) In the fuel cell system (10) of the invention, the controller (20) may cause the fuel cell stack (12) to perform the specific power generation during a period from when the operation of the moving object on which the fuel cell system (10) is mounted is stopped to when the operation of the moving object is resumed. As a result, even if the temperature drops due to a sudden change in the environment in which the fuel cell system is disposed while the operation of the moving object is stopped, the water inside the fuel cell stack can be purged before the operation of the moving object is resumed.

Moreover, the present invention is not limited to the above-described disclosure, and various configurations can be adopted therein without departing from the essence and gist of the present invention.

1. A fuel cell system including a fuel cell stack configured to generate electricity by electrochemical reactions between an oxygen-containing gas and a fuel gas,
the fuel cell system comprising:
an oxygen-containing gas supply device configured to provide the oxygen-containing gas to be supplied to the fuel cell stack;
a fuel gas supply device configured to provide the fuel gas to be supplied to the fuel cell stack; and
a controller configured to control the oxygen-containing gas supply device and the fuel gas supply device,
wherein the controller is configured to cause the fuel cell stack to perform a specific power generation for a first predetermined period of time for increasing water inside the fuel cell stack after stopping normal operation of the fuel cell system, and
wherein after the specific power generation executed for the first predetermined period of time, the controller is configured to cause the oxygen-containing gas to be supplied to the fuel cell stack for a second predetermined period of time during which the water inside the fuel cell stack is reduced.

2. The fuel cell system according to claim 1, further comprising:
a temperature sensor configured to detect a temperature of the fuel cell stack,
wherein the controller causes the fuel cell stack to start the specific power generation when the temperature becomes equal to or lower than a predetermined temperature threshold after stopping the normal operation of the fuel cell system.

3. The fuel cell system according to claim 2, wherein the controller supplies the fuel gas to the fuel cell stack in a case where a state in which the temperature of the fuel cell stack exceeds the temperature threshold has continued for a predetermined period of time after stopping the normal operation of the fuel cell system.

4. The fuel cell system according to claim 1, wherein the controller decreases the oxygen-containing gas to be supplied to the fuel cell stack during the specific power generation to an amount at which a ratio of the oxygen-containing gas to the fuel gas becomes lower than a reference ratio determined by a target amount of electricity.

5. The fuel cell system according to claim 1, wherein the controller causes the fuel cell stack to perform the specific power generation during a period from when an operation of a moving object on which the fuel cell system is mounted is stopped to when the operation of the moving object is resumed.
